(19) United States
(12) Patent Application Publication
(10) Pub. No.: US 2024/0313276 A1
(43) Pub. Date: Sep. 19, 2024

(54) Dynamic Control for Battery Cell Formation

(71) Applicant: NATIONAL INSTRUMENTS CORPORATION, Austin, TX (US)

(72) Inventors: Piet Vanassche, Blanden (BE); Jeroen Van den Keybus, Kessel-lo (BE)

(21) Appl. No.: 18/183,755

(22) Filed: Mar. 14, 2023

(51) Int. Cl. H01M 10/44; H02J 7/00

(52) U.S. Cl. CPC H01M 10/446; H01M 10/441; H01M 10/443; H02J 7/0069

(57) ABSTRACT

Systems, methods and devices for performing dynamically controlled battery cell formation. A formation process is performed on a plurality of battery cells. A series connection is established through each of the plurality of battery cells and a cycling device. Each battery cell is coupled to a respective monitoring device to monitor performance during cell formation. The monitoring devices provide indications to a controller when their monitored battery cells experience a status change. Responsive to the indication, instructions are provided for synchronously modifying the series connection through the first battery cell and modifying a voltage amplitude at the cycling device. Modifying the series connection through the first battery cell may include switching a voltage polarity across the first battery cell shorting the series connection around the first battery cell without modifying the series connection through the other battery cells.

### FIELD OF THE INVENTION

The present invention relates to the field of battery cell manufacturing, formation and aging.

### DESCRIPTION OF THE RELATED ART

Electric vehicles are growing in market share, and are becoming a larger portion of vehicle fleets in developed nations. Battery electric vehicles (BEVs), or fully electric vehicles, represent a large portion of the electric vehicle market. Battery cells are an essential component of a BEV, as they do not rely on fossil fuels for energy, and so the increase in market share of BEVs is expected to correspond to a large increase in demand for BEV battery cells. A typical workflow for BEV cell constructions involves cell manufacturing, formation, and aging.

Yields in battery cell manufacturing processes are typically below 80% due to variability in the involved electrochemical processes, and this yield rate has been difficult to improve. In addition, formation and aging are time-consuming processes that take on the order of days to complete. Aging includes repeatedly taking cell measurements to detect defects, but defects may be difficult to detect and may present significant risk to product performance and safety. Current implementations to address these issues become cost prohibitive at scale. Battery cell factories employ equipment and infrastructure to cycle and age a massive number of cells, potentially millions at full capacity. Accordingly, improvements in the field, in particular, regarding improvements in efficient and effective high-volume BEV cell formation, aging and manufacturing are desired.

### SUMMARY OF THE INVENTION

Various embodiments are presented herein of systems, methods and devices for performing dynamically controlled battery cell formation. The battery cell formation system may include one or more of a formation tower, a controller, a plurality of battery cell interfaces, and a plurality of battery cell fixtures. The battery cell interfaces and/or the battery cell fixtures may each be configured with dedicated processors, in some embodiments.

In some embodiments, a formation process is performed on a plurality of battery cells. A series connection may be established through each of the plurality of battery cells and a cycling device. A respective monitoring device may be coupled to each battery cell, and each monitoring device is configured to monitor performance of its respective coupled battery cell.

In some embodiments, the plurality of battery cells are charged or discharged using the cycling device. In some embodiments, a first indication is received from a first monitoring device that a first battery cell of the plurality of battery cells coupled to the first monitoring device has experienced a status change.

In some embodiments, based on receiving the first indication, instructions are provided for synchronously modifying the series connection through the first battery cell and modifying a voltage amplitude at the cycling device.

Modifying the series connection through the first battery cell may include switching a current polarity through the first battery cell without switching a current polarity through other battery cells. In some embodiments, modifying the series connection through the first battery cell includes shorting the series connection around the first battery cell without modifying the series connection through the other battery cells. The voltage amplitude at the cycling device may be modified to maintain a constant current through the other battery cells before and after modifying the series connection through the first battery cell.

Note that the techniques described herein may be implemented in and/or used with a number of different types of SUTs and/or DUTs, including but not limited to cellular phones, vehicles, portable media players, tablet computers, wearable devices, RF semiconductor components, RF power amplifiers, Front End Modules, transceivers, and various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a production workflow for battery cells, according to some embodiments;

FIG. 2 shows a computer system coupled to a controller, according to some embodiments;

FIG. 3 is a basic computer system block diagram, according to some embodiments;

FIG. 4 is an example illustration of a formation tower architecture, according to some embodiments;

FIG. 5 is a circuit diagram illustrating battery cell interfaces coupled to battery cells, according to some embodiments;

FIG. 6 is a detailed circuit diagram illustrating how a batter cell interface couples to a battery cell fixture, according to some embodiments;

FIG. 7 is a system diagram illustrating battery cell interfaces and fixtures in a formation tower and coupled to a controller, according to some embodiments;

FIG. 8 is an example system diagram of a formation tower, according to some embodiments;

FIG. 9 is a flowchart diagram illustrating a method for dynamically controlling a battery cell formation process, according to some embodiments; and

FIGS. 10A-C are circuit diagrams illustrating various examples of cell control circuitry, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Acronyms

The following is a listing of the acronyms used in the present application:
DUT: Device Under Test
SUT: System Under Test
AC: Alternating Current
IGBT: Insulated Gate Bipolar Transistor
ADC: Analog-to-Digital Converter
PLD: Programmable Logic Device
FPGA: Field Programmable Gate Array
TX/RX: Transmit/Receive
CLK: Clock
LED: Light-Emitting Diode
BCI: Battery Cell Interface
BCF: Battery Cell Fixture
PDU: Power Distribution Unit

### Terms

The following is a glossary of terms used in the present application:

Memory Medium—Any of various types of non-transitory computer accessible memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Processing Element—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. A measurement device may also optionally be further configured as a signal generator to generate signals for provision to a device-under-test. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, a signal generator, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Functional Unit (or Processing Element)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

Wireless—refers to a communications, monitoring, or control system in which electromagnetic or acoustic waves carry a signal through space rather than along a wire.

Approximately—refers to a value being within some specified tolerance or acceptable margin of error or uncertainty of a target value, where the specific tolerance or margin is generally dependent on the application. Thus, for example, in various applications or embodiments, the term approximately may mean: within 0.1% of the target value, within 0.2% of the target value, within 0.5% of the target value, within 1%, 2%, 5%, or 10% of the target value, and so forth, as required by the particular application of the present techniques.

SUT Interface—one or more antenna probes and potentially supporting parts modifying the collective properties the antenna probes and parts are presenting to the electromagnetic radiation associated with wireless signals and giving structural integrity to their assembly, and which may be used to measure the wireless signals generated by the SUT.

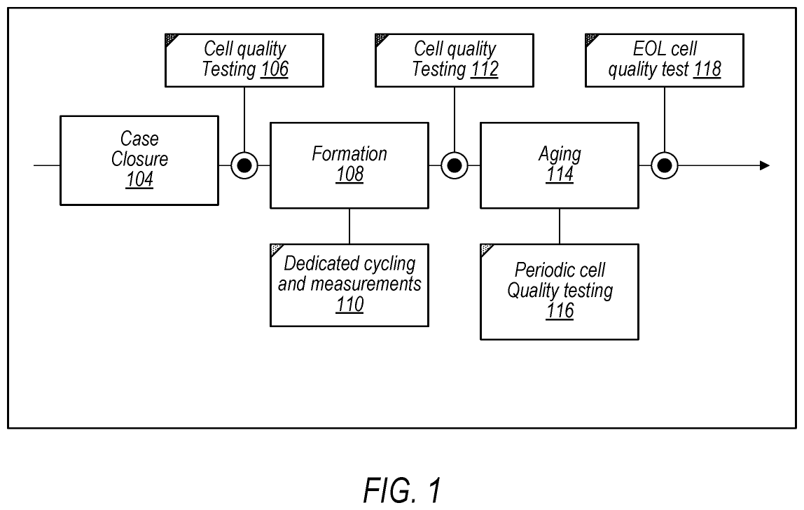

### FIG. 1—Battery Cell Manufacturing Workflow

FIG. 1 is a workflow diagram illustrating a method for manufacturing battery cells, according to some embodiments. At 104, after physically constructing the components of a battery cell, the case closure is performed to contain the battery components. At 106, the quality of the cell is tested prior to the formation process. At 108, a cell formation process is performed where the cell is repeatedly charged and discharged to establish a stable voltage difference across the anode and cathode. After an electrochemical cell is assembled, its chemical structure is changed in order to become ready to use as an energy storage element. This may be done by forcing an electric current from one of the electrodes to the other, whereby an electric potential is developed across the electrodes. Whereas this process generally involves a positive net supply of energy to the cell (‘charging’), the process generally also includes periods of time where the net supply of energy is negative (‘discharging’). After a programmed sequence of current, which generally depends on the cell voltage, temperature, stored or dissipated energy, and/or time, has been applied to the cell, its production is considered complete. The production of each cell typically takes a different amount of time, mainly due to production process variations of the cell's components.

The quality of the cell is determined through testing after completion of the formation process at step 112. The rejection rate after completing cell formation may be as high as 20%, where only 80% of the formed cells are of sufficiently high quality to proceed to aging and deployment. This may be because, during production, a considerable number of cells exhibit deviations on e.g. their temperature, terminal voltage, or another physical property. If the deviation exceeds a specified quality threshold, the production is said to have failed. Failed cells preferably are removed as early as possible from the production process, to be replaced by another cell to initiate production. Embodiments implement dynamic monitoring and controlling during the cell formation process to improve battery yields.

It is desirable to not interrupt the production process, since it would represent a different programmed sequence of current than intended, which is generally unacceptable for quality control. In some previous implementations, cells are supplied by individual, independent electronic power sources. In view of a scaled-up production, it is a disadvantage that the number of power sources equals the number of cells. It is also a disadvantage that an accurate cell current is independently measured for each cell. In most cases, each power source also may have the ability to source and sink current.

In other previous implementations, the cells are connected in series and a single electronic power source is used for production. This method enforces the same current to all cells at any time, which imposes constraints to the programmed sequence of current on a per-cell basis. This leads to the disadvantage of a less efficient production process. In view of a scaled-up production, it is a disadvantage that the terminal voltage of the series connected cells is limited to the voltage supported by the power source, imposed by insulation properties, or imposed by safety regulations.

Embodiments herein improve on these legacy processes by implementing dedicated measurement and control circuitry 110 at the level of individual cells to monitor cell performance, so that faulty cells may be rapidly identified during the formation process, improving the efficiency and increasing the output of the overall manufacturing process.

At 114, the cells that have completed the formation process and satisfied cell quality testing are moved to an aging tower to stabilize the chemical composition of the cells. In some embodiments, the same measurement and control circuitry used in the formation process may be repurposed to periodically test cell quality during the aging process at step 116, whereby defective cells may be identified and addressed, and the cell fixture may be repurposed for a new cell. The measurement and control circuitry may be coupled to the cell within a battery cell fixture, where the battery cell fixture is modular and is configured to be movable between the formation tower and the aging tower without disconnecting the battery cell from the measurement and control circuitry. Finally, at 118 an end of line (EOL) cell quality test is performed on the aged cells prior to deploying them to market.

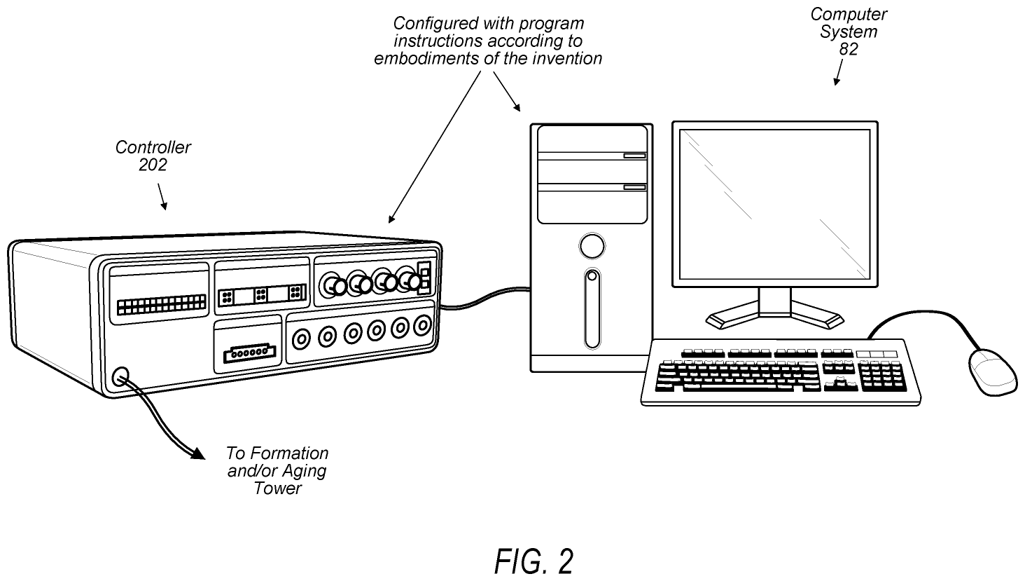

### FIG. 2—Computer System and Controller

FIG. 2 is a system diagram illustrating a computer system 82 coupled to a controller 202, according to some embodiments. The controller may be coupled via a wired or wireless connection to a formation tower and/or an aging tower, and may be configured to receive information from the formation and/or aging towers during a cell manufacturing process and provide instructions to modify parameters of the manufacturing process. For example, the controller may receive information from measurement and control circuitry that is monitoring a particular battery cell within a battery cell fixture during cell formation, and in response to this information the controller may provide instructions to synchronously remove the battery cell from the formation process and modify the voltage used in the formation process to maintain a constant current for the remaining battery cells. Additionally or alternatively, the controller may perform analytics on information received from the formation or aging tower and provide and provide an analysis of this information to the computer system to display on a display device, whereby a user may determine whether to modify the manufacturing process based on the displayed information.

Advantageously, detailed feedback on the status of the manufacturing process at a per-cell resolution may enable a user to dynamically intervene in the manufacturing to improve overall yield and efficiency. For example, defective cells may be identified earlier in the manufacturing process (e.g., during the formation process or during the aging process), the defective cells may be removed from the manufacturing process for repair or disposal, and the battery cell fixtures housing the defective cells may be repurposed for the manufacture of new battery cells.

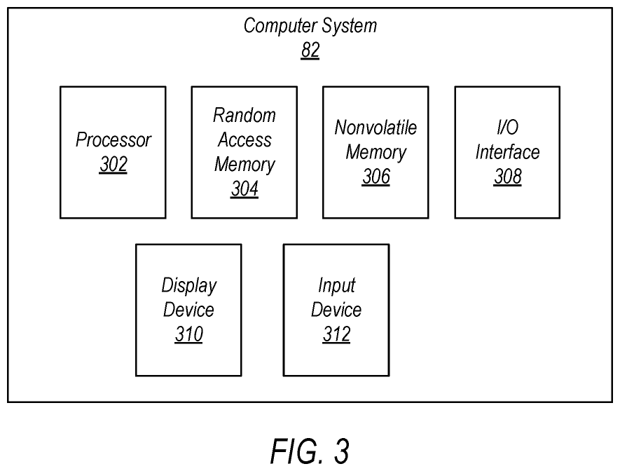

### FIG. 3—Computer System Block Diagram

FIG. 3 illustrates a simplified block diagram of the computer system 82. As shown, the computer system 82 may comprise a processor 302 that is coupled to a random access memory (RAM) 304 and a nonvolatile memory 306 to implement embodiments described herein. For example, the processor may execute program instructions stored on the nonvolatile memory to control a cell formation and/or aging tower. The computer system 82 may also comprise an input device 312 for receiving user input (e.g., a keyboard, mouse, touchpad, etc.) and a display device 310 for presenting output on a display. The computer 82 may also comprise an Input/Output (I/O) interface 308 that is coupled to the controller 202 to provide output/instructions to control cell formation and receive input and/or information related to individual cells.

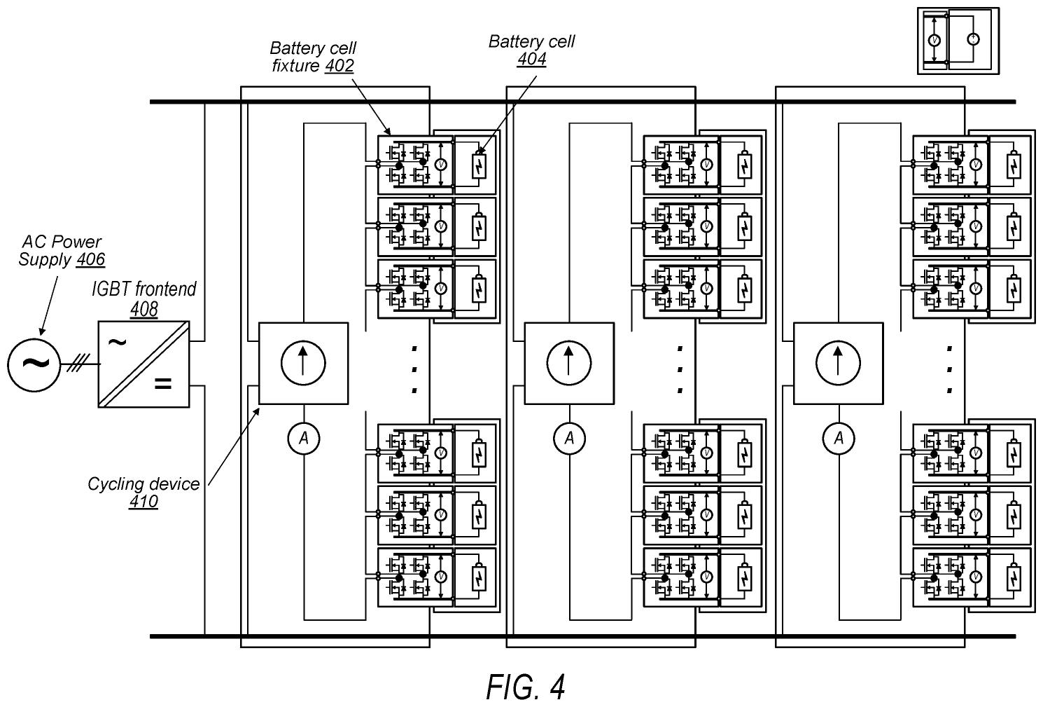

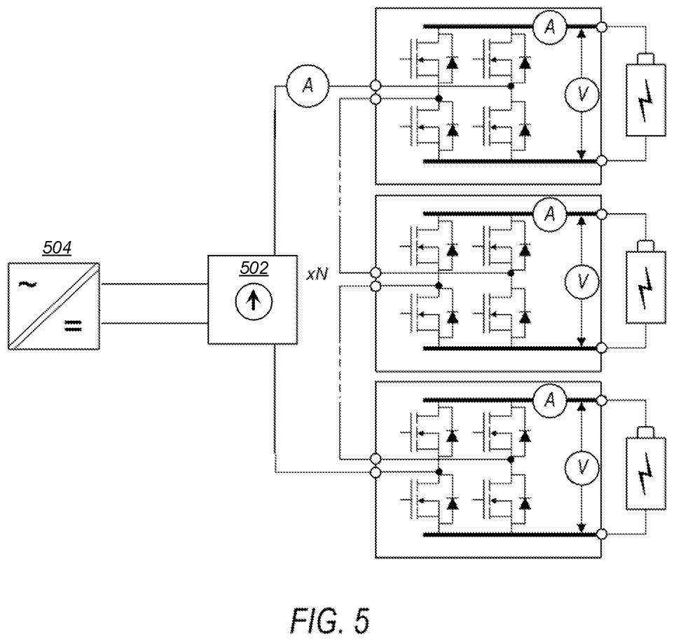

### FIGS. 4-5—Cell Formation Station

FIG. 4 is a schematic diagram of a cell formation station configured to perform a cell formation process on a plurality of battery cells. As illustrated in FIG. 4, the cell formation station includes a plurality of formation towers connected in parallel to an insulated gate bipolar transistor (IGBT) frontend 408 acting as an active front end. The frontend is configured to receive power from an alternating current (AC) power source 406 and provide this power to a cycling device in a form appropriate for driving a charge/discharge cycle on the battery cells. The cycling device then drives the cell formation current through a plurality of respective cycling devices 410 housed within each of the formation towers. Each formation tower includes the cycling device which is connected in series to a plurality of battery cell fixtures 402. Each battery cell fixture includes a cavity configured to house a battery cell 404, and measurement and control circuitry configured to monitor the battery cell and modify the series connection with the cycling device (e.g., toggling the connection on and off, or changing the polarity of the connection). For example, the measurement and control circuitry may be configured to controllably connect or disconnect the housed battery cell from the series connection with the cycling device. The cycling device and each of the battery cell fixtures may be communicably coupled (e.g., via a wired or wireless connection) to a controller (e.g., such as the controller 202) to provide information related to the formation process and receive control instructions. For example, the control instructions may cause the cycling device to modify the cycling amplitude for the charge/discharge cycles, and may cause the measurement and control circuitry to connect and/or disconnect its respective battery cell from the series connection with the cycling device.

FIG. 5 is a more detailed view of three battery cell fixtures coupled to battery cells and in a series connection with a cycling device 502. The circuit shown in FIG. 5 includes an alternating current/direct current (AC/DC) converter 504 that converts, as one example 50/60 Hz AC into an intermediate voltage (typically 650-800V). This intermediate voltage is used to supply one or more converters acting as current sources, i.e. driving a set output current into the series-connected battery cells, thereby adjusting its output voltage to that of the series-connected cells.

In some embodiments, formation may be efficiently performed on a large string of battery cells connected in series with a single cycling device, where the controller directs the cycling device to charge and discharge select battery cells in the string of battery cells. A single magnitude of current may be selected for the entire string, and each battery cell may be charged and discharged with dynamic control implemented by the controller. Each battery cell may be held within a respective battery cell fixture that contains dedicated measurement circuitry configured to monitor and control the formation process for the battery cell. Advantageously, decoupling the measurement and control circuitry from the power electronics that drive the charge/discharge current may enable monitoring and control of the formation process at the level of individual battery cells while also reducing costs through the economy of scale of utilizing a single large-wattage power source to drive the cycler for a large number (e.g., hundreds or even thousands) of cells. For example, the cost of a power source per kilowatt of capacity decreases exponentially for larger capacity power sources, so decoupling the measurement and control circuitry from the driving power supply enables fine individual-cell control without incurring the increased expense of coupling each cell to an individual (small wattage) power supply. The measurement and control circuitry may be embedded within the fixture that houses the battery cell. Time-sensitive communication may be enabled using the TX/RX bus.

Advantageously, the described embodiments simplify the process of managing the manufacturing process and equipment for a fleet of cells. Power may be provided to the measurement and control circuitry within the fixture as it moves through different stages of the manufacturing process. Software data models may be employed by the measurement and control circuitry to evaluate the quality of a cell and evaluate the quality of the manufacturing process. Formation recipe profiles may be created and managed through feedback provided by the measurement and control circuitry. The health of the system may be tracked and predicted on the level of individual cells, providing detailed feedback to guide the manufacturing process. Further, quality and yield results of the manufacturing process may be correlated with the formation recipe profile, and data models may be employed to modify the formation recipe profile to improve results.

In some embodiments, the measurement and control circuitry may be configured to perform self-test methodologies to evaluate the quality and efficacy of the equipment. Integrated diagnostics within the each battery cell fixture may allow errors with either the battery cell or the measurement and control circuitry to be quickly identified and repaired.

In some embodiments, a calibration procedure (e.g., using a golden DUT as a battery cell) may be integrated directly into the battery cell fixture. In some embodiments, test signals may be built into a ‘smart palette’ to characterize the quality of the connectivity to the system and the cycler device. This modular approach to cycling and instrumentation may advantageously enable rapid replacement and servicing of defective components.

Embodiments herein may also provide enhanced safety features. For example, real-time diagnostics at the individual cell level may be used to mitigate thermal runaway and/or gas leaks. The measurement and control circuitry may be configured with infrared temperature detection to identify and mitigate overheating battery cells, and may be configured to automatically disconnect the overheating or leaking battery cells.

Software may deploy a graphic user interface (GUI) to allow a user to instantly understand the behavior and health of the system and rapidly identify the source of potential errors. Automatic identification of system characteristics, models and health diagnostics during testing and manufacturing may enable users to efficiently guide and correct the testing and manufacturing process.

Without applying constraints on the operator or test profile, embodiments described herein automatically perform data capture, data processing, and analytics. This information may be automatically reported back in real time, whenever valuable and/or actionable information about the system has been detected. For example, analytic software may be configured to process the real time data received from the plurality of cells to determine whether pre-configured criteria indicative of cell failure or other actionable events have occurred. In this way, the unmanageably large quantity of data produced by the plurality of cells in a formation process may be processed and analyzed in software before it is presented to a user.

For example, in the case that a battery cell is connected to a power supply, the system may automatically detect characteristics before an event, such as an open circuit voltage. The processor may then analyze the transient response of the DUT, such as the exponential and linear portions of the response, overshoot and steady state responses, time derivatives of measured variables, partial derivatives, linear and non-linear basis functions, forward and inverse transforms of real and complex data, etc. Based on the analysis, the processor in the fixture may automatically disconnect the battery cell from the power supply to avoid damage to the cell, overheating, damage to the fixture, or other issues.

Based on the automatically acquired and processed data, some embodiments may compute various performance metrics, figures of merit such as equivalent circuit parameters, time constants, poles/zeros, eigenvalues, statical correlations, repeatability and variance. The analysis may detect outliers based on past data, execute scientific machine learning analysis, and so on. Some embodiments may compute confidence levels for predictions, such that analysis results with low confidence may not be reported.

Embodiments herein provide low-cost time synchronized measurement capabilities that can be integrated directly into the fixturing and are synced with the power electronics. Test and data acquisition may be time-coordinated plant-wide and fed into the analytics backbone for the purpose of cell quality analysis and equipment predictive maintenance.

In some embodiments, the formation tower may have switches fixed thereon. The cell fixture may be configured with a switch that is configurable to connect or disconnect from the series circuit of a formation tower. The battery cells may be inserted into the fixture, and may remain in the fixture as they are moved (e.g., by robot) between stages of manufacturing (e.g., from the formation tower to an aging tower). Since the fixture moves along with the cell and is reused across subsystems of the manufacturing process, the number of times the cell is manually manipulated may be reduced, decreasing the likelihood of physical trauma or damage to the cell. For example, removing and reinserting a cell into a new fixture may run the risk of introducing a burr on the cell contacts, or otherwise scratching or damaging the cell. Cells may be inserted and removed from a fixture as desired (e.g., if a cell is determined to be faulty, the fixture may be repurposed for housing a new cell).

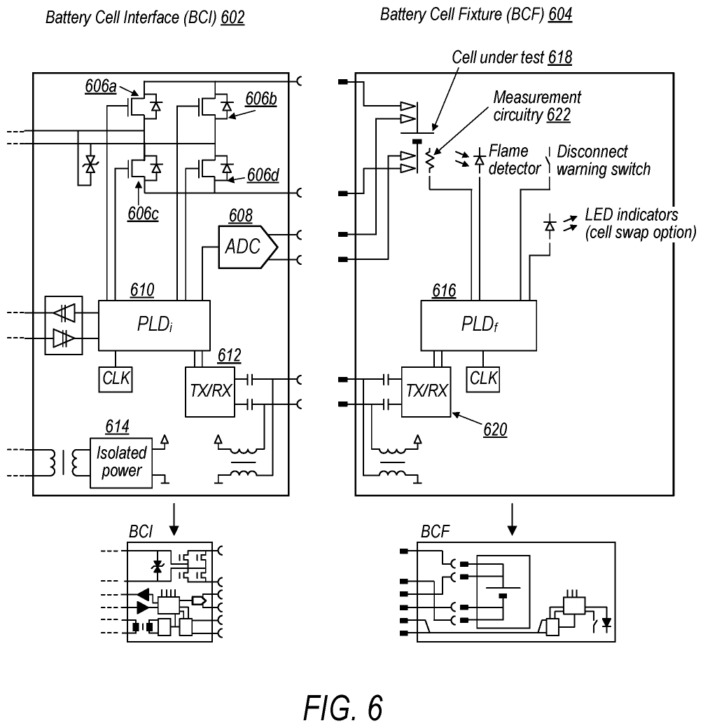

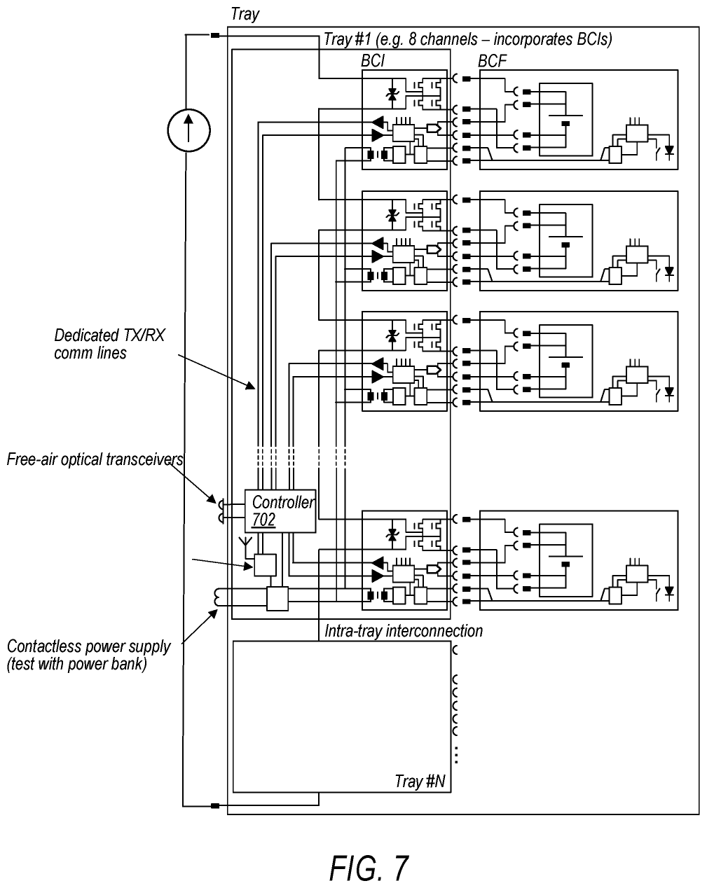

### FIGS. 6-7—Modular Battery Cell Fixture and Interface

FIG. 6 is a detailed circuit diagram illustrating how a batter cell interface (BCI) couples to a modular battery cell fixture (BCF), according to some embodiments. In the illustrated embodiment, a battery cell interface is configured with a dedicated processor such as the programmable logic device (PLDi) 610, where the “i” indicates that it is the dedicated processor for the interface. The PLDi is coupled to a clock (CLK) and a transmit/receive (TX/RX) port that is used to receive and transmit information to a controller. The PLDi 610 is coupled to and configured to toggle four switches 606a-606d, which may be organized into different configurations to reverse the polarity of the series connection for the battery cell, or to short the series connection around the battery cell. For example, for a configuration that charges the battery cell with current going in the forward direction, 606a and 606d may be closed and 606b and 606c may be opened. To reverse the direction of current to discharge the cell, 606b and 606c may be closed and 606a and 606d may be opened. To short the circuit around the cell, bypassing the cell to have no driven current, either 606a and 606b may be closed and 606c and 606d may be opened, or alternatively 606c and 606d may be closed and 606a and 606b may be opened.

The PLDi is also coupled to the BCF through an analog-to-digital converter (ADC), which is used to receive analog measurements from the measurement circuitry of the BFC and convert them to a digital format for processing by the PLDi. The BCI may be installed with a tray of a formation tower, in some embodiments.

The BCF is also configured with a dedicated processor (PLDf) 616, which is coupled to a TX/RX port 620, measurement circuitry 622, a flame detector, an emergency disconnect switch, and light emitting diode (LED) indicators. The PLDf may be configured to receive certain high-priority measurement signals originating from the battery cell, such as flame detection, overheating, short or open circuits, or other critical cell failures. The PLDf may be coupled to non-transitory memory that stores a serial number of the housed battery, and it may provide this information as well as safety data through the TX/RX port to the controller (e.g., at periodic intervals during formation). As explained in greater detail below, the BCF may be configured to autonomously disconnect the battery cell responsive to a critical failure indication (e.g., without providing an indication to the controller and waiting for instructions to disconnect). Alternatively, in some embodiments PLDi 610 may be configured to autonomously reconfigure the switches 606a-d to short the series connection around the housed battery cell in the event of a critical failure measurement from the measurement circuitry.

FIG. 7 is a system diagram illustrating battery cell interfaces and fixtures in a formation tower and coupled to a controller, according to some embodiments. As illustrated, a tray (Tray #1) is configured with 8 channels (4 of which are explicitly illustrated), each with an installed BCI. The formation tower also includes receiving cavities for 8 BCFs, each of which is configured to hold a respective battery cell. The BCIs are each connected in a single series connection with a cycling devices. The BCIs are also connected via TX/RX communication lines through their respective TX/RX ports with a controller 702. The controller may be an FPGA, and ASIC, or another type of programmable hardware element, in various embodiments. The controller is coupled to a computer system such as the computer system 82 via wireless optical transceivers. The controller may be configured to dynamically control the formation process, by receiving information from the BCIs indicating status changes in battery cells during formation, performing analytics on the received information, requesting specific measurements from the battery cells, and providing instructions to modify connections to the respective battery cells.

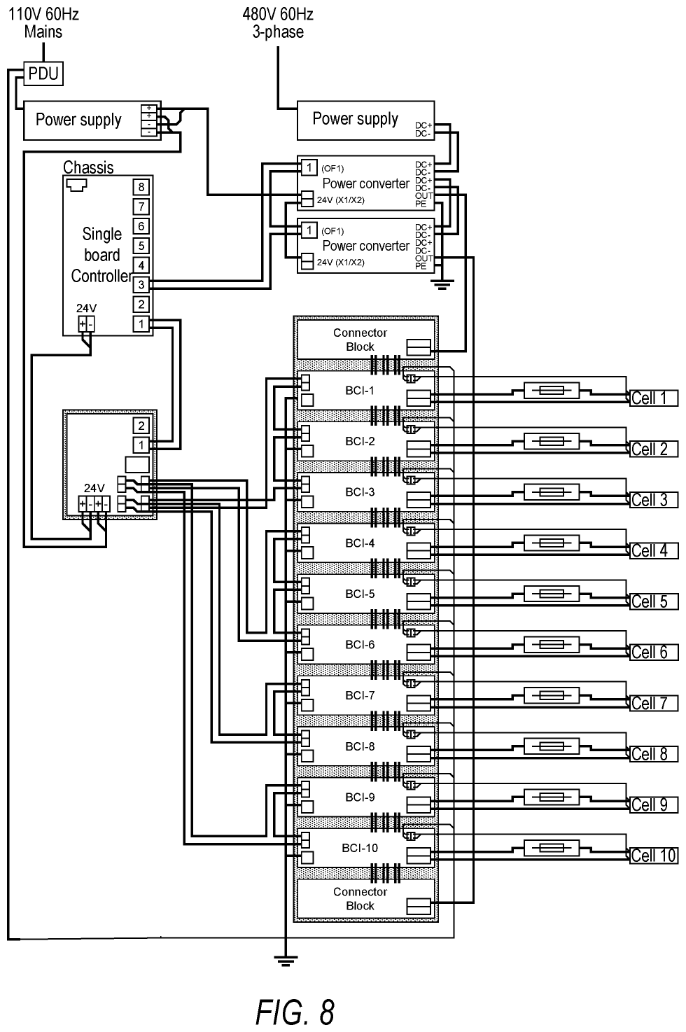

FIG. 8 is a system diagram of an alternative architecture for a formation tower, according to some embodiments. FIG. 8 differs from the architecture shown in FIG. 7 in part because the ten BCIs shown in the formation tower in FIG. 8 couple directly to respective battery cells, rather than coupling to modular BCFs that house the battery cells. In FIG. 8, measurement circuitry may be contained within each BCI.

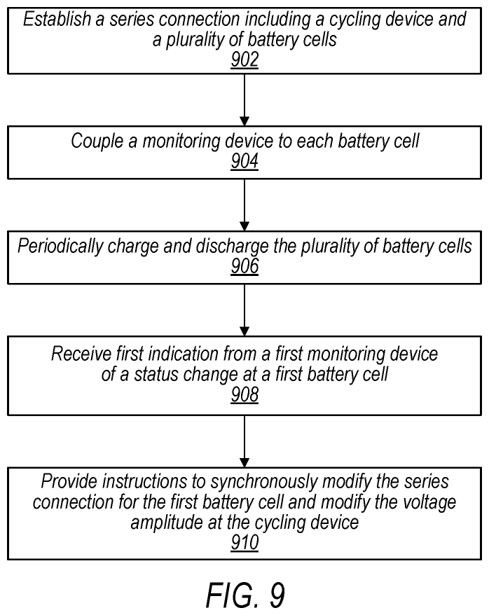

### FIG. 9—Flowchart for Dynamic Battery Cell Formation

FIG. 9 is a flowchart diagram illustrating a method for performing dynamically controlled cell formation on a plurality of battery cells, according to some embodiments. The method shown in FIG. 9 may be used in conjunction with any of the computer systems, memory media or devices shown in the above Figures, among other devices.

In some embodiments, a computer system may include a processor and memory, and the memory may store program instructions executable by the processor to perform the method elements described in reference to FIG. 9. In various embodiments, the processor may be a parallel multi-processor system, a field programmable gate array (FPGA), or an application specific integrated circuit (ASIC). In various embodiments, the described method steps may be directed by a combination of the controller processor (e.g., such as controllers 202 and 702 in FIGS. 2 and 7, respectively), dedicated processors 610 of the BCIs, and/or by dedicated processors of the BCFs 616. In various embodiments, some of the method elements shown may be performed concurrently, in a different order than shown, or may be omitted. Additional method elements may also be performed as desired. As shown, this method may operate as follows.

At 902, a series connection is established through each of the plurality of battery cells and a cycling device. The series connection may be structured, for example, as shown in the circuit diagrams of FIGS. 4 and 7-8. Each battery cell may be contained within a modular battery cell fixture, such as the single cell fixture illustrated in FIG. 6. The battery cell fixtures may be configured to hold a battery while being moved between a formation tower and an aging tower, without disconnecting the battery cell from the fixture. The battery cell fixture may be configured to interface with a batter cell interface (e.g., the BCI illustrated in FIG. 6) while inserted into the formation tower. The BCI may be configured with a processor coupled to a plurality of switches. The switches may be toggled in various configurations to reverse the polarity of the current of the series connection through the battery cell, and/or to short the series connection around the battery cell. The processor may be configured to control the switches based on information received from the monitoring circuitry and/or based on instructions received from a controller (e.g., the controller 702 in FIG. 7).

At 904, a respective monitoring device is coupled to each of the plurality of battery cells. Each monitoring device is configured to monitor performance and operational parameters of each respective coupled battery cell. The monitoring device may be installed as monitoring circuitry on each battery cell fixture. Each battery cell fixture may also have installed thereon a processor (e.g., the programmable logic device 616) coupled to monitoring circuitry to direct the monitoring of operational parameters of the housed battery cell. The operational parameters may include a variety of properties, such as voltage, impedance, current, temperature and flame detection.

At 906, each of the plurality of battery cells are charged or discharged using the cycling device. As one example, each of the battery cells may initially be in a discharged and unformed state, and the cycling device may initialize the formation process by introducing a current to charge each of the battery cells. The formation process may be dynamically controlled as some cells are detected to be experiencing problems (e.g., overheating or insufficient charging), or become fully charged before others. As described in greater detail below with respect to steps 908-910, information received from the monitoring devices may be analyzed by a processor to dynamically modify the series connection through the battery cells to improve the efficiency and speed of the formation process.

In some embodiments, the cycling device is powered by a single power source to charge or discharge each of the plurality of battery cells.

At 908, an indication is received from a monitoring device that a battery cell coupled to the monitoring device has experienced a status change. For clarity, the battery cell that experiences the status will be sometimes referred to as the “first battery cell”, to distinguish it from the other battery cells undergoing cell formation. The status change may be of a variety of types, and the nature of the status change may be described by the indication. For example, the first battery cell may have fully charged or discharged, it may have completed the formation process, it may have failed to meet a quality threshold, or it may be experiencing overheating, a short circuit or an open circuit, among other possibilities. The monitoring device may provide the indication to a processor within the battery cell fixture and/or a processor within the battery cell interface, which in at least some embodiments is then provided to the controller.

At 910, based on receiving the indication, instructions are provided for synchronously modifying the series connection through the first battery cell and modifying a voltage amplitude at the cycling device. The voltage amplitude may be modified to maintain a constant current through each of the plurality of battery cells other than the first battery cell, before and after modifying the series connection through the first battery cell.

Depending on the nature of the indication, either the battery cell fixture or the battery cell interface may autonomously provide instructions to modify the connection of the first battery cell, or alternatively the indication may be transmitted to the controller and the controller may provide the instructions to modify the series connection through the first battery cell. For example, an urgent detected status change such as a detected flame or excessive overheating may result in an automatic disconnect of the first battery cell by the battery cell fixture or the battery cell interface and/or the provision of instructions to the controller to modify the voltage amplitude at the cycling device, without waiting for instructions from the controller. Alternatively, less urgent status changes such as a completed charge or discharge may be transmitted via the I/O port to the controller, and the controller may subsequently provide synchronous instructions to the cycling device to modify the voltage amplitude and to the processor of the battery cell interface to toggle one or more of the switches to modify the series connection for the first battery cell. For example, when the battery is fully charged or fully discharged, the instructions may cause the switches to be toggled to reverse the polarity of the connection, to switch from charging to discharging of the first battery cell, or vice versa. In these embodiments, modifying the series connection through the battery cell may include switching the current polarity through the first battery cell (e.g., switching from charging to discharging, or vice versa) without switching the current polarity through other battery cells in the formation tower. The instructions further instruct the cycling device to modify the voltage amplitude to maintain a constant current through all of the other battery cells, given the polarity reversal at the first battery cell.

In some embodiments, modifying the series connection through the first battery cell includes shorting the series connection around the first battery cell. The instructions further instruct the cycling device to modify the voltage amplitude to maintain a constant current through all of the other battery cells, given the short around at the first battery cell. For example, if the voltage was not modified at the cycling device, the removal of the first battery cell from the series connection would result in an increase in the current through the other battery cells (e.g., because the first battery cell's electric resistance has been removed from the circuit). Accordingly, the voltage amplitude at the cycling device may be modified to counteract this increase.

The series connection may be shorted around the first battery cell in cases where the status change indicates that the first battery cell is overheating (e.g., when the measured temperature exceeds a temperature threshold or a rate threshold), is malfunctioning, or has successfully completed the formation process. When the first battery cell has completed the formation process, after shorting the series connection around the first battery cell, the battery cell fixture may be removed from a formation tower and inserted into an aging tower without decoupling the first monitoring device from the first battery cell, to proceed with the aging process. The receiving cavity for the battery cell fixture may then receive another fixture containing an unformed battery cell.

In some embodiments, an indication may be received by the controller that formation is complete for all of battery cells of the plurality of battery cells. Responsive to this indication, the plurality of battery cells may be automatically disconnected from the cycling device.

In some embodiments, a self-diagnostic indication is received from a monitoring device that the monitoring device is experiencing a malfunction. Responsive to the self-diagnostic indication, instructions may be provided for synchronously shorting the series connection around the battery cell and modifying the voltage amplitude at the cycling device. The battery cell may be then removed for diagnostics and/or repair of the monitoring device.

In some embodiments, additional battery cells may be added to the series connection for charging without disrupting the battery cells that are currently charging or discharging. In some embodiments, the additional battery cells may be interleaved in the series connection adjacent to one or more discharging battery cells. Advantageously, interleaving the added battery cells with alternating polarity in this way may reduce the power drain on the cycling device, as the discharging battery cell may provide voltage to assist in charging the adjacent charging battery cell. In other words, power may be preserved during the formation process by alternating charging and discharging cells in the formation tower.

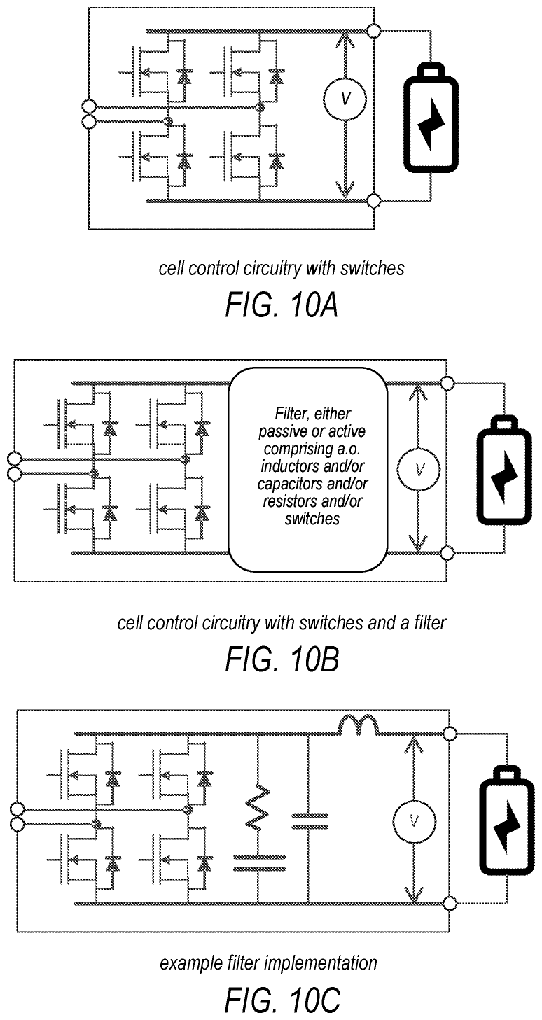

FIGS. 10A-C are circuit diagrams illustrating various examples of cell control circuitry, according to some embodiments. FIG. 10A illustrates cell control circuitry including four switches configured to modify the direction of current through the battery cell. FIG. 10B shows cell control circuitry that additionally includes a filter (e.g., an inductor capacitor (LC) filter) between the four switches and the battery cell, where the filter may be either passive or active and includes inductors, capacitors, resistors and/or additional switches. FIG. 10C shows a specific example of a filter that includes a resistor, and inductor and two capacitors.

In some embodiments, the filter serves to shape and control current and voltage transients that happen when the state of the switches alters. They may also serve to suppress the current ripple that arises when the switches are modulated on a continuous basis to control the average current flowing into the connected battery cell.

### Additional Description

The following numbered paragraphs described additional aspects of the described embodiments.

Embodiments herein present methods for producing a plurality of electrochemical cells, by using a set of switches for each cell to configure whether and how the cell is connected in a series connection of other configured cells. In some embodiments, the method utilizes a single power source to force a configurable current through the series connection of configurable cells. Production of the cells is governed by controlling the state of the switches depending on each cell's voltage, temperature, state of production, and/or charging/discharging time, among other possibilities.

In some embodiments, a current measurement having a high accuracy is used to inform the state of the switches. Advantageously, the cost of the current measurement is divided among the plurality of cells.

Some embodiments use semiconductor switches such as field effect transistors where current is conducted by majority carriers. Since these switches do not have a fixed voltage drop in the on-state, conduction losses may be reduced arbitrarily at the expense of more expensive switch(es). In addition, these switches may be turned on and off without substantive energy consumption.

In some embodiments, only 2 switches are used for a cell, allowing the cell to be included or excluded from the series connection of other configured cells, but if included, only in one orientation. If a reversed current is desired for that cell, the power source current may be reversed.

In some embodiments, 4 switches are used for a cell, allowing the polarity of that cell in the series connection of other configured cells to be changed, without altering the polarity for the other cells in the tower. Advantageously, the current through each cell may be reversed without reversing the polarity of the power source.

In some embodiments, the overall state of production of each cell is controlled to further improve the efficiency of the power source, including delaying the start of the production of a cell, and (temporarily or permanently) removing the cell from the series connection of other configured cells. This provides the possibility that cells that have completed production may be disconnected without immediately removing them physically from the series connection of the other configured cells. Further, cells that are to be produced may already have been physically inserted in the series connection of other configured cells before the start of production. In view of a scaled-up production, these embodiments provide an advantage of fully utilizing the power source, by implementing a continuous process where the production completion of a cell is followed immediately by the production start of a new cell.

In some embodiments, the production failure of a cell is simply a form of production completion. The net effect remains that production of the other cells is not interrupted. An added advantage is that failed cells may be removed early from the series connection of other configured cells.

In some embodiments, a voltage limiting device is placed across the configured terminals of a cell with its respective switches. Advantageously, no excessive voltage is developed across a failing, opened switch, and production of other cells in the series connection of other configured cells is not interrupted.

In some embodiments, a single voltage measurement device having a high accuracy is used to determine the voltage across the series connection of configurable cells. During production, by selecting the proper state of switches, the series connection can be made to include only a single cell, allowing an accurate measurement of each cell's voltage with a single voltage measurement device.

In some embodiments, the power source current is repeatedly reduced to zero for a short period of time, during which the voltage of a selected cell may be acquired. By selecting each next cell for each short period of time, the repeatedly updated voltage of each cell is available for configuring the switches for production of cells in the relatively long time between the short periods of time.

In some embodiments, the method also determines preferable positions of new cells in the series connection of other configured cells, those positions preferably interleaving with positions of cells whose orientation is about to be reversed in the series connection of other configured cells. In this case, the voltage of a cell after changing orientation is at least partially compensated by the voltage of a neighboring cell whose charging process has been recently initiated. Advantageously, a larger number of cells may be produced with a given power source compared to the number of cells that can produced when all cells are in the series connection with the same orientation.

In some embodiments, groups of adjacent new configured cells, with their respective switches, have preferable positions between groups of adjacent configured cells, with their respective switches, that are already in the production stage. In this case an additional switch may be placed across each group of adjacent configured cells, the switch enabling removal of the group with all related switches. Advantageously, adjacent cells may be physically inserted or removed as a group, increasing production efficiency. In some embodiments, a voltage limiting device is placed across said additional switch, preventing development of a high voltage across the switch in case either the switch or any of the cells or their respective switches fails in a group of adjacent configured cells.

In some embodiments, the described methods may be performed by a standard computer processor coupled to memory. Alternatively, in some embodiments a programmable hardware element may be utilized to perform the described methods. A programmable hardware element may include various hardware devices comprising multiple programmable function blocks connected via a programmable interconnect. Examples include FPGAs (Field Programmable Gate Arrays), PLDs (Programmable Logic Devices), FPOAs (Field Programmable Object Arrays) and CPLDs (Complex PLDs). The programmable function blocks may range from fine grained (combinatorial logic or look up tables) to coarse grained (arithmetic logic units, graphics processing units (GPUs), or processor cores). A programmable hardware element may also be referred to as “reconfigurable logic.” As another option, an integrated circuit with dedicated hardware components such as an Application Specific Integrated Circuit (ASIC) may be used to perform the described method steps.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for performing a formation process on a plurality of battery cells, the method comprising:
establishing a series connection through each of the plurality of battery cells and a cycling device;
coupling a respective monitoring device of a plurality of monitoring devices to each battery cell of the plurality of battery cells, wherein each monitoring device is configured to monitor performance of each respective coupled battery cell;
charging or discharging each of the plurality of battery cells using the cycling device;
receiving a first indication from a first monitoring device that a first battery cell of the plurality of battery cells coupled to the first monitoring device has experienced a status change; and
based on receiving the first indication, providing instructions for synchronously modifying the series connection through the first battery cell and modifying a voltage amplitude at the cycling device.

2. The method of claim 1,
wherein modifying the series connection through the first battery cell comprises switching a current polarity through the first battery cell without switching a current polarity through battery cells of the plurality of battery cells other than the first battery cell.

3. The method of claim 1,
wherein modifying the series connection through the first battery cell comprises shorting the series connection around the first battery cell without modifying the series connection through battery cells of the plurality of battery cells other than the first battery cell.

4. The method of claim 1,
wherein the voltage amplitude is modified to maintain a constant current through each of the plurality of battery cells other than the first battery cell before and after modifying the series connection through the first battery cell.

5. The method of claim 1,
wherein the status change comprises one of:
the first battery cell fully charging or discharging;
the first battery cell completing the formation process; or
the first battery cell failing to meet a quality threshold.

6. The method of claim 1, further comprising:
receiving a second indication from a second monitoring device that a temperature of a second battery cell of the plurality of battery cells has exceeded a temperature threshold;
based on receiving the second indication that the temperature of the second battery cell has exceed the temperature threshold, providing instructions for synchronously shorting the series connection around the second battery cell and modifying the voltage amplitude at the cycling device.

7. The method of claim 1, further comprising:
receiving an indication that formation is complete for the plurality of battery cells; and
based at least in part on determining that formation is complete for the plurality of battery cells, automatically disconnecting the plurality of battery cells from the cycling device.

8. The method of claim 1,
wherein modifying the series connection across the first battery cell comprises shorting the series connection around the first battery cell,
wherein the first monitoring device is coupled to the first battery cell within a battery cell fixture, wherein the method further comprises:
after shorting the series connection around the first battery cell, removing the battery cell fixture from a formation tower and inserting the battery cell fixture into an aging tower without decoupling the first monitoring device from the first battery cell.

9. The method of claim 1, further comprising:
receiving a self-diagnostic indication from a second monitoring device of the plurality of monitoring devices coupled to a second battery cell that the second monitoring device is experiencing a malfunction; and
based on receiving the self-diagnostic indication that the second monitoring device is experiencing the malfunction, providing instructions for synchronously shorting the series connection around the second battery cell and modifying the voltage amplitude at the cycling device.

10. The method of claim 1,
wherein the cycling device is powered by a single power source to charge or discharge each of the plurality of battery cells.

11. The method of claim 1, further comprising:
inserting a second battery cell into the series connection for charging, wherein the second battery cell is interleaved in the series connection adjacent to at least one discharging battery cell.

12. A battery cell interface, comprising:
a plurality of switches;
an input/output (I/O) port;
a processor coupled to the plurality of switches and the IO port, wherein the processor is configured to:
connect a first battery cell to a series connection with a plurality of second battery cells and a cycling device within a formation tower, wherein the first battery cell is configured to be charged or discharged by the cycling device when connected to the series connection;
receive information from the first battery cell describing one or more operational parameters of the first battery cell; and
based at least in part on the one or more operational parameters of the battery cell, toggle at least a subset of the plurality of switches to reverse a current polarity through the battery cell from the series connection.

13. The battery cell interface of claim 12,
wherein toggling the plurality of switches to reverse the current polarity through the first battery cell does not alter a current polarity through the plurality of second battery cells.

14. The battery cell interface of claim 12,
wherein the plurality of switches comprises four switches,
wherein the four switches are configurable to short the series connection around the first battery cell.

15. The battery cell interface of claim 12, wherein the processor is further configured to:
provide the information describing the one or more operational parameters of the first battery cell through the I/O port to a controller over a wired connection; and
receive an indication from the controller responsive to providing the information, wherein reversing the current polarity through the battery cell is performed responsive to receiving the indication from the controller.

16. The battery cell interface of claim 12,
wherein the one or more operational parameters comprise one or more of:
a temperature of the battery cell;
a charging current of the battery cell;
a discharging current of the battery cell; and
an impedance of the battery cell.

17. A controller, comprising:
a non-transitory computer-readable memory medium; and
a processor coupled to memory medium, wherein the processor is configured to execute program instructions stored on the memory medium to:
provide instructions to a cycling device to periodically charge and discharge a plurality of battery cells in a series connection with the cycling device;
receive, from a first monitoring device coupled to a first battery cell of the plurality of battery cells, a first indication that the first battery cell has experienced a status change;
responsive to receiving the first indication, provide first instructions to the cycling device to modify a voltage amplitude of the cycling device and provide second instructions to the first monitoring device to modify the series connection through the first battery cell synchronously with said modifying the voltage amplitude of the cycling device.

18. The controller of claim 17,
wherein modifying the series connection through the first battery cell comprises switching a current polarity through the first battery cell without switching a current polarity through battery cells of the plurality of battery cells other than the first battery cell.

19. The controller of claim 17,
wherein the cycling device is powered by a single power source to charge and discharge the plurality of battery cells.

20. The controller of claim 17,
wherein the processor comprises one of:
a parallel multi-processor system;
a field programmable gate array (FPGA); or
an application specific integrated circuit (ASIC).
